(19) United States
(12) Patent Application Publication
(10) Pub. No.: US 2016/0250778 A1
(43) Pub. Date: Sep. 1, 2016

(54) RUBBER COMPRESSION MOLDING USING PLASTIC MOLD ASSEMBLY WITH METAL INSERTS

(71) Applicant: Caterpillar Inc., Peoria, IL (US)

(72) Inventors: Eric E. Halla, Peoria, IL (US); Brittany Hancock, Chillicothe, IL (US); James R. Carlberg, Peoria, IL (US)

(73) Assignee: Caterpillar Inc., Peoria, IL (US)

(21) Appl. No.: 15/148,479

(22) Filed: May 6, 2016

(51) Int. Cl. B29C 33/02; B29C 43/58; B29C 43/52

(52) U.S. Cl. CPC B29C 33/02; B29C 43/52; B29C 43/58; B33Y 10/00

(57) ABSTRACT

A method of manufacturing a rubber component by compression molding is provided. The method includes receiving a rubber molding material in a plastic mold assembly. The plastic mold assembly includes a mold body having a cavity for receiving the rubber molding material. The cavity corresponds to a shape of the rubber component to be molded. The method includes receiving a plurality of metal inserts within a plurality of holes in the mold body. The plurality of metal inserts is conducting heat to the rubber molding material. The method further includes compressing the rubber molding material received within the cavity of the mold body to form the rubber component.

### TECHNICAL FIELD

The present disclosure relates to manufacture of components by rubber compression molding, and more specifically relates to a plastic mold assembly having metal inserts and a method of manufacturing a rubber component by the plastic mold assembly.

### BACKGROUND

Rubber compression molding is a well known technique of molding that involves placing. a rubber molding material in a heated cavity of a mold assembly and then compressing the rubber molding material for obtaining a desired shaped rubber component. During the rubber compression molding, the rubber molding material and the mold assembly are subjected to high temperature and pressure conditions. Conventionally, mold assemblies made of a metallic material are used for rubber compression molding of components. However, for molding a new component, a new corresponding mold assembly has to be manufactured. Manufacturing of metallic mold assemblies involves longer lead times and higher cost. Moreover, manufacturing metallic mold assemblies of complex shapes can be a cumbersome task. The above limitations inhibit the flexibility of the design as well as generate expense to store the metallic mold assemblies. Replacing metallic mold assemblies with 3D printed plastic mold assemblies can resolve the above mentioned problems related to lead time, cost and flexibility of design. However, the plastic mold assemblies have not been commonly used due to insulation properties of the material. The rubber compression molding requires heat in order to cure rubber. However, in case of plastic mold assemblies, a proper heat transfer does not take place in the mold assembly. As a result, this could lead to had parts or uneven curing of the rubber molding material. Therefore, there is a need for a solution to overcome the problems faced with the use of plastic mold assemblies in the rubber compression molding for manufacturing rubber components.

U.S. Pat. No. 5,094,607, hereinafter referred to as '607 patent, discloses a plastic mold for rotational molding. The plastic mold, used in lieu of a conventional metal mold, is constructed from a fiber reinforced thermoset plastic resin having a heat distortion point above the melt point of the thermoplastic polymeric material from which an article is molded. Metal or other dissimilar material may be used to provide different coefficients of heat transfer at preselected portions of mold. The entire mold may include a thermal coefficient modifier to increase the heat transfer rate of the mold uniformly over the entire mold in addition to the preselected portions. However, the plastic mold disclosed in '607 patent is related to rotational molding.

### SUMMARY OF THE DISCLOSURE

In one aspect of the present disclosure, a method of manufacturing a rubber component by compression molding is provided. The method includes receiving a rubber molding material in a plastic mold assembly. The plastic mold assembly includes a mold body having a cavity for receiving the rubber molding material. The cavity corresponds to a shape of the rubber component to be molded. The method includes receiving a plurality of metal inserts within a plurality of holes in the mold body. The plurality of metal inserts is adapted to conduct and transfer heat to the rubber molding material inside the mold body, and provides structural support to the mold body during the compression molding. The method further includes compressing the rubber molding material received within the cavity of the mold body to form the rubber component. The molding material is pushed against the cavity by placing the plastic mold assembly into a pressing machine.

In another aspect of the present disclosure, a plastic mold assembly for molding a rubber component by compression molding is provided. The plastic mold assembly includes a mold body having a cavity for receiving a rubber molding material. The cavity corresponds to a shape of the rubber component to be molded. The plastic mold assembly includes a plurality of metal inserts removably received within a plurality of holes in the mold body. The plurality of metal inserts is adapted to conduct heat to the rubber molding material.

Other features and aspects of this disclosure will be apparent from the following description and the accompanying drawings.

### BRIEF DESCRIPTION OF THE DRAWING

FIG. 1 is a perspective view of a plastic mold assembly for manufacturing a rubber component by rubber compression molding, according to one concept of the present disclosure;

FIG. 2 is an exploded view of the plastic mold assembly of FIG, I and a rubber molding material;

FIG. 3 is a perspective view of the plastic mold assembly compressing the rubber molding material; and

FIG. 4 is a perspective view of a plastic mold assembly having a plurality of metal inserts when compressing a rubber molding material, according to another concept of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

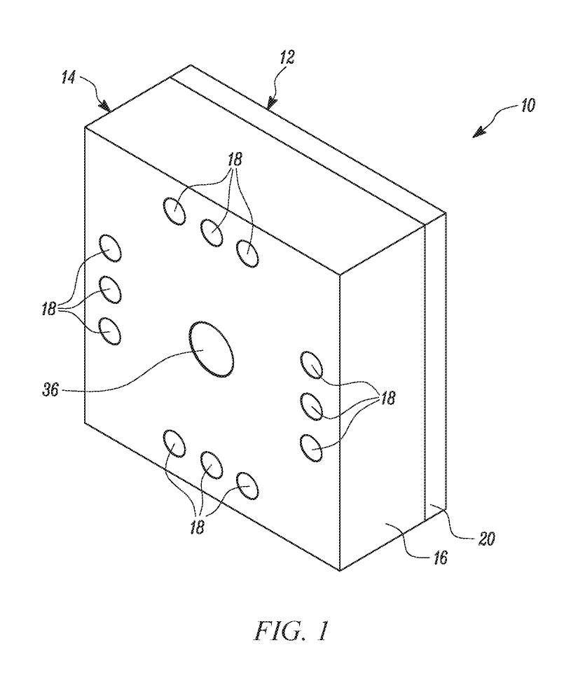

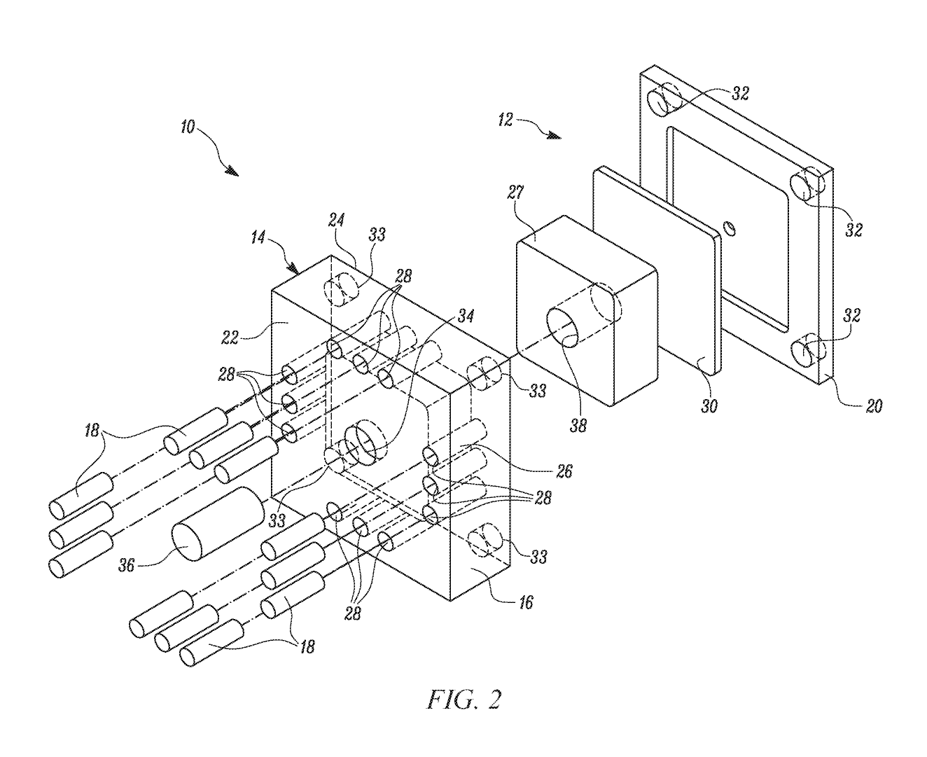

FIG. 1 illustrates a perspective view of a plastic mold assembly 10, The plastic mold assembly 10 includes a first mold half 12 and a second mold half 14. The second mold half 14 includes a cavity 26 (shown in FIG. 2) for receiving a rubber molding material 27 (shown in FIG. 2). The rubber molding material 27 is compressed between the first mold half 12 and the second mold half 14 for manufacturing a rubber component (not shown).

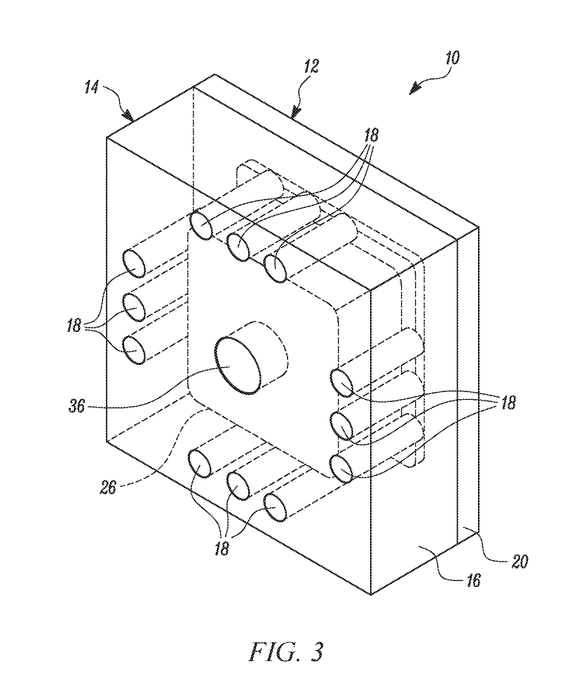

In the present embodiment, the second mold half 14 of the plastic mold assembly 10 includes a mold body 16 and a number of metal inserts 18 and 36 removably received within the mold body 16. Based on dimensional and operational characteristics of the rubber component to be manufactured, the first mold half 12 may include a plastic lid 20 for covering the mold body 16. During rubber compression molding, the plastic mold assembly 10 is positioned between platens (not shown) of a pressing machine (not shown). The pressing machine is appropriately sized for manufacturing the rubber component. In one example, the platens of the pressing machine may be heated. The plastic mold assembly 10 is explained in detail in the description with the support of FIG. 2 and FIG. 3.

Referring to FIG. 2, the mold body 16 includes a first surface 22 and a second surface 24 opposite to the first surface 22 and facing the first mold half 12. The mold body 16 includes the cavity 26 extending from the second surface 24 and towards the first surface 22. The cavity 26 is formed for receiving the rubber molding material 27 therein. Dimensional characteristics of the cavity 26 are defined to conform to the rubber component to be manufactured. Therefore, the dimensional characteristics of the cavity 26 may vary based on the rubber component to be manufactured.

Further, the mold body 16 is provided with a number of holes 28 extending from the first surface 22 to the second surface 24, and disposed along an outer periphery of the cavity 26. The mold body 16 also includes a hole 34 extending from the first surface 22 to the cavity 26. Dimensional characteristics of the hole 34 are defined to conform to the plastic mold assembly 10 and the rubber component to be manufactured. The holes 28 and 34 are adapted to removably receive the metal inserts 18 and 36, respectively. The metal inserts 18 and 36 are adapted to conduct heat to the rubber molding material 27 in the cavity 26, and also to provide structural strength to the mold body 16 during the rubber compression molding. The metal inserts 18 and 36 are arranged in the holes 28 and 34 in such a manner that portions of the metal inserts 18 and 36 extend out from the first surface 22 of the mold body 16. The metal inserts 18 and 36 come in contact with a pressing tool (not shown) during the compression, and prevent a pressing force from getting transferred to the mold body 16 thereby preventing its damage. Also, each of the metal inserts 18 and 36 is independently removable without affecting the other metal inserts 18 and 36 present in the mold body 16.

The metal inserts 18 and 36 may be made of materials that may include, but are not limited to, steel, iron, aluminum or any other metal known in the art. The number of metal inserts 18 and 36 to be inserted in the mold body 16 may depend on various factors, such as the rubber component to be manufactured, shape of the rubber component, structural strength and an amount of heat transfer required by the plastic mold assembly 10.

The first mold half 12 includes the plastic lid 2 which is provided with guide holes 32. The guide holes 32 are disposed for guiding the plastic lid 20 towards the mold body 16 of the second mold half 14 when compressing the rubber molding material 27. The mold body 16 includes corresponding guide holes 33 for aligning with the plastic lid 20. In one example, one or more studs (not shown) may be disposed in the guide holes 32 and 33 for aligning the plastic lid 20 with the mold body 16. In an alternative embodiment, based on dimensional and operational characteristics of a rubber component to be manufactured, the first mold half 12 may include a metal cover 30. The plastic lid 20 and the metal cover 30 may be provided in order to manufacture the rubber component. In other embodiments, where a rubber component to be manufactured is different from the rubber component of the present embodiment, the plastic mold assembly 10 may not include the plastic lid 20 and the metal cover 30.

As shown in FIG. 2, the holes 28 are positioned around and outside the cavity 26, and the hole 34 is defined at about the center of the cavity 26. In an example, a diameter of the hole 34 is larger than a diameter of each of the holes 28 due to the dimensional characteristics of the rubber component. The number and dimensional characteristics of the holes 28 and 34 may vary according to the dimensional characteristics of the rubber component to be manufactured. The present embodiment discloses twelve holes 28, each receiving one of the metal inserts 18 therein and the hole 34 receiving a metal insert 36 therein. The metal insert 36 is received in the hole 34 in such a manner that a portion of the metal insert 36 extends out of the first surface 22. In an example, an outer diameter of the metal insert 36 positioned in the cavity 26 is larger than an outer diameter of each of the twelve metal inserts 18 positioned around the cavity 26. The large size of the metal insert 36 provides it with improved heat conducting capacity and offers better structural rigidity to the mold body 16. Variation in the dimensions and positioning of the metal inserts 18 and 36 corresponds to the shape of the rubber component to be manufactured. For example, in the present embodiment, the rubber component to be manufactured includes a hole in the center and therefore, the rubber molding material 27 is also shown with a corresponding hole 38.

In the present embodiment, shape of the cavity 26 is substantially cuboidal. Further, the metal inserts 18 and 36 are of a cylindrical shape. The metal cover 30 is also of a rectangular shape. It should be appreciated that the dimensional characteristics of the various components of the plastic mold assembly 10 are not limited to what are explained and shown in the figures, and may vary in accordance to the dimensional characteristics of the rubber component to be manufactured, without departing from the scope of the disclosure.

FIG. 3 shows the plastic mold assembly 10 when the rubber molding material 27 is being compressed between the first mold half 12 and the second mold half 14. When the first mold half 12 is compressed against the second mold half 14, the metal inserts 18 come into contact with the metal cover 30 and prevent the mold body 16 from getting over-compressed and cracked. Further the metal inserts 18 and 36 are adapted to conduct heat from the metal cover 30 and throughout the plastic mold assembly 10, and allow the rubber molding material 27 to cure fully within the plastic mold assembly 10. The metal inserts 18 and 36 also conduct the heat from the platens of the pressing machine to the rubber molding material 27 in the cavity 26.

The plastic mold assembly 10 is made by an additive manufacturing technique. In the present embodiment, the plastic mold assembly 10 is made by using a Three-Dimensional (3D) printing technique. Although, the present embodiment explains the manufacturing of the plastic mold assembly 10 by using the 3D printing technique, it should be noted that the scope of the present disclosure is not limited to manufacturing of the plastic mold assembly 10 by the 3D printing technique.

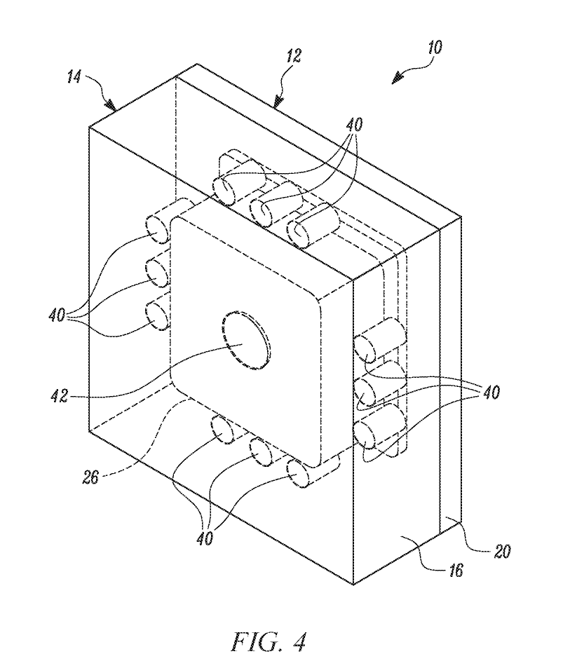

Referring to FIG. 4, the plastic mold assembly 10 is provided with metal inserts 40 and 42 when compressing the rubber molding material 27, according to another embodiment of the present disclosure. In the present embodiment, the mold body 16 is provided with metal inserts 40 and 42 which are extending from the second surface 24 to inside of the mold body 16. The metal inserts 40 and 42 are disposed along a depth of the cavity 26 and do not extend till the first surface 22 of the mold body 16. Therefore, in the present embodiment, holes (not shown) receiving the metal inserts 40 and 42 are not through-holes.

### INDUSTRIAL APPLICABILITY

The present disclosure relates to the plastic mold assembly 10 and a method of manufacturing the rubber component by the rubber compression molding using the plastic mold assembly 10. The plastic mold assembly 10 includes the first mold half 12 and the second mold half 14. The second mold half 14 includes the mold body 16 with the metal inserts 18, 36, 40, 42, The metal inserts 18, 36, 40, 42 are made from metals having high heat conducting capacity along with high load carrying capacity. Also, factors, such as the size and a number of metal inserts 18, 36, 40, 42 to be used are determined based on size and shape of the rubber component to be manufactured,

The plastic mold assembly 10 is made by using any known additive manufacturing technique, such as the 3D printing technique. The 3D printing technique offers flexibility to produce mold assemblies of different shapes with less lead time when compared to conventional steel mold assemblies. The second mold half 14 of the plastic mold assembly 10 is provided with the holes 28 and 34. The metal inserts 18, 40 are placed in the holes 28, and the metal insert 36, 42 is placed in the hole 34. The second mold half 14 is also provided with the cavity 26.

During operation, the rubber molding material 27 is placed in the cavity 26 of the second mold half 14 of the plastic mold assembly 10. The rubber molding material 27 is compressed against the cavity 26 of the mold body 16 for manufacturing the rubber component. The rubber molding material 27 is compressed by pushing the platen of the pressing machine against the mold body 16.

The method of manufacturing the rubber component by compression molding includes receiving the rubber molding material 27 in the plastic mold assembly 10. Once the rubber molding material 27 is received in the cavity 26 of the mold body 16, the method includes receiving the metal inserts 18, 36, 40, 42 within the holes 28 and 34 in the mold body 16. The metal inserts 18 and 36 are positioned in and around the cavity 26 and are in contact with the platens of the pressing machine. The metal inserts 18 and 36 conduct heat from the heated platens, and transfer the heat to the rubber molding material 27 in the cavity 26.

The method further includes compressing the rubber molding material 27 received within the cavity 26 of the mold body 16 to form the rubber component. The rubber molding material 27 is pushed against the cavity 26 by placing the plastic mold assembly 10 into the pressing machine and by compressing the rubber molding material 27 against the cavity 26 by the platens of the pressing machine.

The method further includes heating of the cavity 26 and the metal inserts 18, 36, 40, 42 to a desired temperature to transfer heat to the rubber molding material 27. The desired temperature may depend on factors, such as dimensional and operational characteristics of the rubber component to be manufactured. In one example, the method includes contacting the heated platen of the pressing machine with the metal inserts 18, 36, 40, 42 during the rubber compression molding. In another example, the method includes forming the plastic mold assembly 10 by the additive manufacturing technique. In yet another example, the method includes forming the plastic mold assembly 10 by using the 3D printing technique.

The method of manufacturing the rubber component using the 3D printed plastic mold assembly 10 reinforced with heat conducting metal inserts 18. 36, 40, 42 disposed inside the mold body 16 offers an effective technique for manufacturing of the rubber components of different complex shapes and sizes. Since the plastic mold assembly 10 is manufactured by the additive manufacturing technique, an overall cost and lead time of manufacturing the plastic mold assembly 10 is lower when compared with the conventional metal mold assemblies. Further, the metal inserts 18, 36, 40, 42 ensure an effective heat transfer throughout the plastic mold assembly 10 thereby allowing the rubber molding material 27 to cure fully within the mold body 16. Also, the extension of the metal inserts 18 and 36 out of the mold body 16 limits degree of compression of the plastic mold assembly 10 and therefore, negates the possibility of failure of the plastic mold assembly 10 and the rubber molding material 27 due to excessive compression or cracking. In one embodiment, the metal inserts 18 may extend from the first surface 22 to the depth of the cavity 26. Therefore, the metal inserts 18 may not extend upto the second surface 24 of the mold body 16. Such an embodiment offers another approach to implement the metal inserts 18 and 36 within the plastic mold assembly 10.

In addition, removability of the metal inserts 18, 36, 40, 42 provides flexibility of application of the plastic mold assembly 10. This would assist in modifying heat absorbing capacity of the plastic mold assembly 10 by varying the number of metal inserts 18, 36, 40, 42 based on varying operational characteristics of the rubber compression molding operation. Also, since each metal insert 18, 36, 40, 42 is individually replaceable, in case of failure of one of the metal inserts 18, 36, 40, 42, the damaged metal insert 18, 36, 40, 42 may be replaced without affecting other metal inserts 18, 36, 40, 42, This would also offer convenience in terms of transportation and handling of the plastic mold assembly 10. Moreover, the rubber molding material 27 does not stick in the cavity 26 during the rubber compression molding operation and in turn eliminates maintenance concerns with regard to cleaning of the plastic mold assembly 10 after the manufacturing of the rubber component. Also, the plastic mold assembly 10 with the metal inserts 18, 36, 40, 42 is capable of withstanding a high number of compression cycles. Therefore, the service life of the plastic mold assembly 10 is increased, and an overall cost associated with manufacturing of the rubber components is reduced. Therefore, the present disclosure offers the plastic mold assembly 10 and the method of manufacturing the rubber component using the plastic mold assembly 10 that are simple, effective, economical, flexible, and time saving.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A method of manufacturing a rubber component by compression molding, the method comprising:
receiving a rubber molding material in a plastic mold assembly, the plastic mold assembly including:
a mold body having a cavity for receiving the rubber molding material, wherein the cavity corresponds to a shape of the rubber component to be molded;
receiving a plurality of metal inserts within a plurality of holes in the mold body, wherein the plurality of metal inserts is conducting heat to the rubber molding material; and
compressing the rubber molding material received within the cavity of the mold body to form the rubber component, wherein the rubber molding material is pushed against the cavity.

2. The method of claim I further comprising heating of the cavity and the plurality of metal inserts to a desired temperature to transfer heat to the rubber molding material.

3. The method of claim 1 comprising contacting a. heated platen of a pressing machine with the plurality of metal inserts during the compression molding.

4. The method of claim 1 comprising forming the plastic mold assembly by an additive manufacturing technique.

5. The method of claim 4 comprising forming the plastic mold assembly by a three-dimensional (3D) printing technique.

6. A plastic mold assembly for molding a rubber component by compression molding, the plastic mold assembly comprising:
a mold body having a cavity for receiving a rubber molding material, wherein the cavity corresponds to a shape of the rubber component to be molded; and
a plurality of metal inserts removably received within a plurality of holes in the mold body, wherein the plurality of metal inserts is adapted to conduct heat to the rubber molding material.

7. The plastic mold assembly of claim 6, wherein the plurality of metal inserts is received within the plurality of holes, wherein a portion of the plurality of metal inserts extends out of a first surface of the mold body. The plastic mold assembly of claim 7, wherein the portion of the plurality of metal inserts is in contact with a platen of a pressing machine for protecting the mold body from over-compression during the compression molding.
